(19) United States
(12) Patent Application Publication
(10) Pub. No.: US 2008/0189257 A1
(43) Pub. Date: Aug. 7, 2008

(54) WORLD-WIDE CLASSIFIED LISTING SEARCH WITH TRANSLATION

(75) Inventors: Garry R. Wiseman, Issaquah, WA (US); Kurt Weber, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/670,103

(22) Filed: Feb. 1, 2007

(51) Int. Cl. G06F 17/30

(52) U.S. Cl. 707/4

(57) ABSTRACT

The claimed subject matter provides a system and/or a method that facilitates querying data across various languages. An interface component can receive data related to a portion of a listing associated with commerce in a first language. An interpreter component can translate a query in a second language to the first language to enable identification of a portion of the listing in the first language.

### BACKGROUND

In many instances, a search engine is utilized to search for information. In general, a search engine is a special program (e.g., computer executable instructions) designed to help find files (e.g., web pages, images, text . . . ) stored on a computer, for example, a public server or on one's own personal computer. A typical search engine allows a user to invoke a query for files that satisfy particular criteria, for example, files that contain a given word or phrase in a title or body. Web search engines generally work by storing information about a large number of web pages retrieved from the World Wide Web (WWW) through a web crawler, or an automated web browser, which follows essentially every link it locates. The contents of each web page are then analyzed to determine how it should be indexed, for example, words can be extracted from the titles, headings, or special fields called meta-tags. Data about web pages is stored in an index database for use in later queries. Some search engines store (or cache) all or part of a source page as well as information about the web pages. When a user invokes a query through the web search engine by providing key words, the web search engine looks up the index and provides a listing of web pages that best-match the criteria, usually with a short summary containing the document's title and/or parts of the text.

In general, the usefulness of a search engine depends on the relevance of the results it presents to a user and the presentation of such results. While there can be numerous web pages that include a particular word or phrase, some web pages may be more relevant, popular, or authoritative than others. Most search engines employ methods to rank the results to provide a “best” result first. How a search engine decides which pages are the best matches, and what order the results should be shown in, varies widely from one engine to another. Conventionally, the technique for displaying what the search engine considers relevant information about a web page to a user can based solely on traffic. In other words, query results are traditionally ranked based on the number of links and the traffic associated with such links. Thus, a particular web page can be ranked very high solely because a link within such web page has a relatively high amount of traffic. Utilizing the page structure of web pages to prioritize query results is not an efficient and/or user specific technique.

With the intense growth of the Internet, people all over the globe are utilizing computers and the Internet to escalate commerce activity (e.g., sales, purchases, etc.). Although the capabilities of the Internet allow commerce activities to be implemented around the world, the various languages spoken are constant boundaries that restrict the global reach of computers with Internet connections. Although conventional techniques enable particular web pages, web sites, and the like to be translated, each computer and/or device must be specifically equipped to handle such translations with an appropriate plug-in for a specific language. Even with such traditional techniques, a particular device and/or computer may not be equipped with the specific language (e.g., the appropriate plug-in for the foreign language encountered) in light of the immense amount of languages existing in the world. Based on such linguistic boundaries, the Internet and corresponding searching cannot reach full potential of enabling a true world-wide-web.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate identifying a portion of data in a disparate language based on a translation of a received query. An interpreter component can translate a received data query in order to identify query results in disparate languages which can enlarge the scope of a data search. Particularly, the interpreter component can receive a query, translate such query into a disparate language (e.g., in comparison to the language the query received), and locate relevant query results in the languages the query was translated. Moreover, the interpreter component can translate a portion of the relevant query results so as to enable comprehension from the origin of the query provider.

In accordance with one aspect of the claimed subject matter, the interpreter component can utilize a range component that can manipulate the scope of the query based on geographic location. The range component can limit, expand, etc. the search of the interpreter component based at least in part upon a user preference. Thus, a query can be limited to a portion of a geographic location and/or expanded to include most any suitable geographic location. Furthermore, the interpreter component can utilize a communication component that can employ a communication forum to allow a client speaking a first language and a client speaking a second language to communicate. In other aspects of the claimed subject matter, methods are provided that facilitate identifying query results related to a listing associated with commerce independent of a language.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates identifying a portion of data in a disparate language based on a translation of a received query.

FIG. 2 illustrates a block diagram of an exemplary system that facilitates identifying query results related to a listing associated with commerce independent of a language.

FIG. 3 illustrates a block diagram of an exemplary system that facilitates translating a query into a disparate language to locate various listings regardless of the language related to the listing.

FIG. 4 illustrates a block diagram of an exemplary system that facilitates implementing a language independent environment to identify a listing and translating such listing into a substantially similar language as a relevant query.

FIG. 5 illustrates a block diagram of exemplary system that facilitates employing universal communication corresponding to a first client and a second client.

FIG. 6 illustrates a block diagram of an exemplary system that facilitates identifying a portion of data in a disparate language based on a translation of a received query.

FIG. 7 illustrates an exemplary methodology for identifying query results related to a listing associated with commerce independent of a language.

FIG. 8 illustrates an exemplary methodology that facilitates implementing a commerce environment for communication independent of a language boundary.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “store,” “interface,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

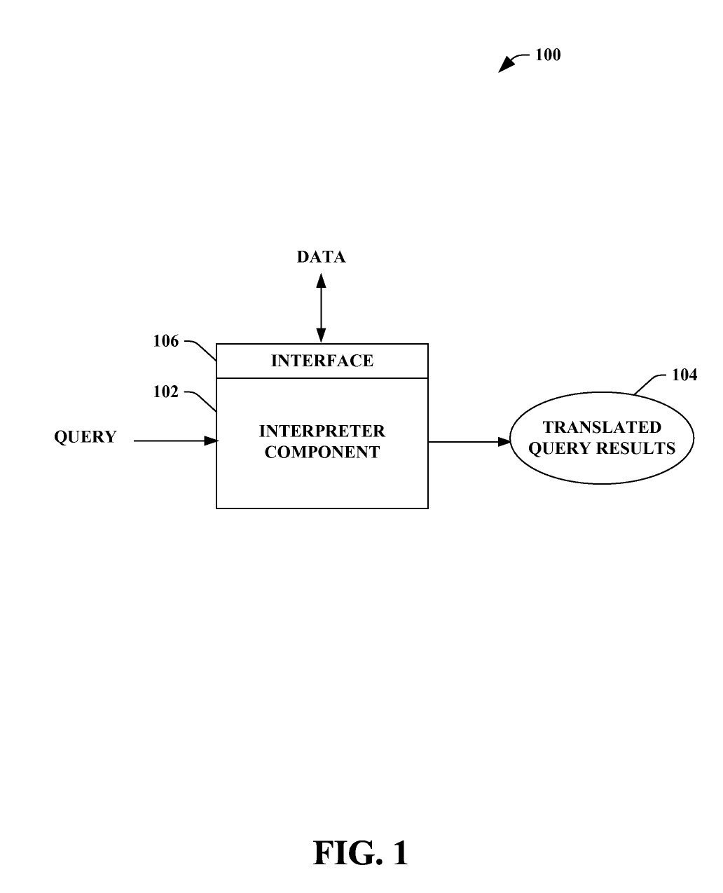

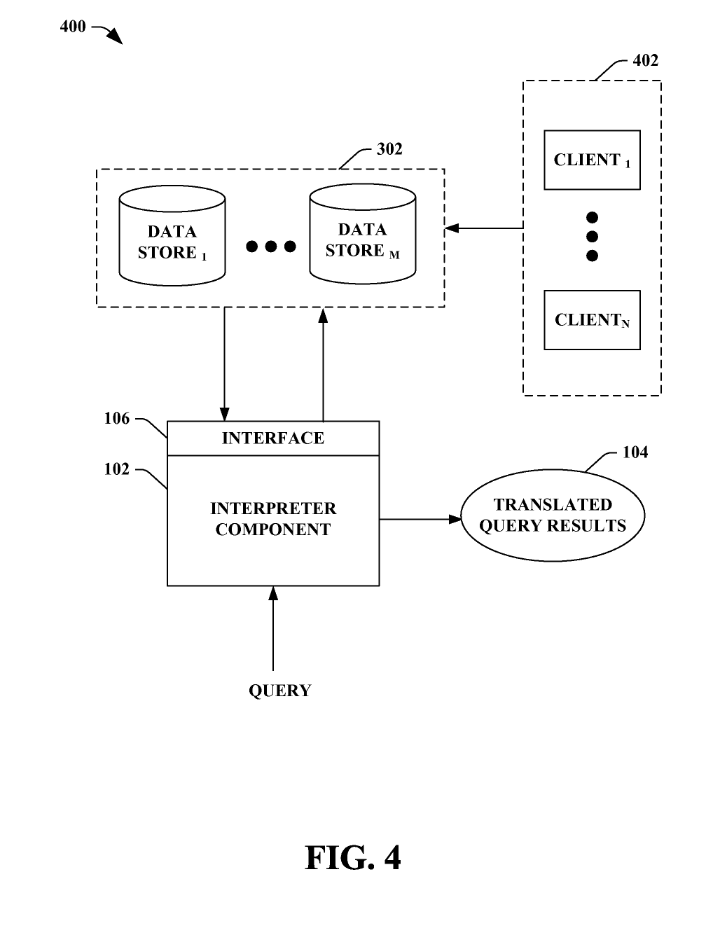

Now turning to the figures, FIG. 1 illustrates a system 100 that facilitates identifying a portion of data in a disparate language based on a translation of a received query. The system 100 can include an interpreter component 102 that can provide query results independent of a language. In other words, the interpreter component 102 can identify a portion of data that satisfies a received query regardless of the language of the query received and/or the language of the data queried. In particular, the interpreter component 102 can receive a query in a first language. The first language query can be translated into a second language that can be substantially similar to the second language, wherein the data to be queried can be related to the second language. Upon identifying relevant query results, the interpreter component 102 can translate the query results into the first language in order to provide at least one translated query result 104. Thus, the interpreter component 102 can provide query results in a first language (e.g., translated query results 104) based on querying data that is in a disparate language. Additionally, the interpreter component 102 can provide translation for most any suitable data associated with a relevant query result such as, but not limited to, currency conversion, phone extensions, measurement conversions, etc.). It is to be appreciated and understood that the system 100 can be manipulated to enable an adjustable range to query for listings (discussed infra) (e.g., increased for a larger geographic search, decreased for a smaller geographic search, isolated search based on a user-defined geographic location, etc.). Furthermore, the interpreter component 102 can extract a portion of data from a listing in order to generate at least one keyword that can be translated and/or utilized for identifying relevant query results independent of a language (discussed in detail in FIG. 4).

For instance, a user that can speak a first language can provide a query in order to locate a listing related to commerce. In one example, the listing can be associated with an item, a good, a commodity, an item for sale, a portion of a service, a purchasable item, an item related to commerce, etc. However, based on the uniqueness of a listing, a relevant query result may exist but in a distant geographic location that utilizes a disparate language in comparison to the first language. For example, the first language can be English and the disparate language can be Chinese. The system 100 can receive the query in English, translate such query into Chinese, locate query results associated with the Chinese language, and provide at least one query result which relates to the listing in the disparate language (e.g., Chinese). In addition, the Chinese query result can be translated into English to allow the user to comprehend the identified listing that is relevant. It is to be appreciated that the translated query results 104 can be provided in real-time, dynamically, and/or on-the-fly.

In addition, the system 100 can include any suitable and/or necessary interface component 106 (herein referred to as “interface 106”), which provides various adapters, connectors, channels, communication paths, etc. to integrate the interpreter component 102 into virtually any operating and/or database system(s) and/or with one another. In addition, the interface component 106 can provide various adapters, connectors, channels, communication paths, etc., that provide for interaction with the interpreter component 102, the query, the translated query results 104, and/or any other component, data and the like associated with the system 100.

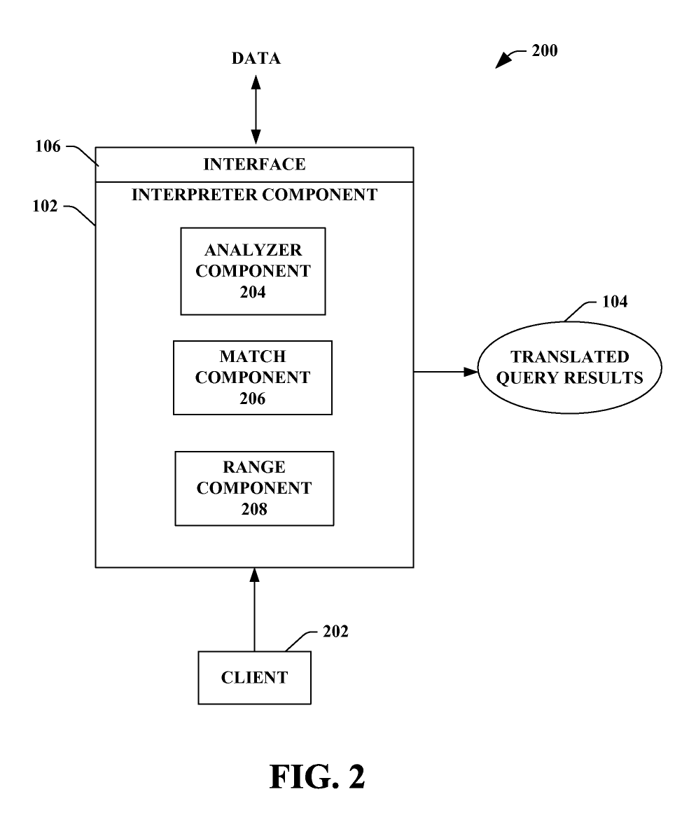

FIG. 2 illustrates a system 200 that facilitates identifying query results related to a listing associated with commerce independent of a language. The interpreter component 102 can receive a query via a client 202, wherein the query can be in a first language. The interpreter component 102 can translate the query into a disparate language in order to provide a search and respective search results in such disparate language. It is to be appreciated and understood that the interpreter component 102 can provide translations for a plurality of languages utilized around the world such as, but not limited to, English, Chinese, Spanish, French, Portuguese, Swahili, German, Russian, Japanese, Bengali, Hindi, Urdu, Arabic, Punjabi, most any variation thereof, most any suitable language spoken around the planet Earth, etc.

The interpreter component 102 can include an analyzer component 204 that can analyze the received query in order to facilitate translating such query into a disparate language so as to find relevant data. In particular, the analyzer component 204 can identify at least on of the following: the language associated with the query; the language associated with the data to which the query can be applied; the possible relevancy of query results associated with the translated query; the geographic range to which the query should apply; and/or most any suitable analysis associated with the system 200. It is to be appreciated that the analyzer component 204 can be incorporated into the interpreter component 102 (as depicted), a stand-alone component, incorporated into a search component (not shown), and/or most any suitable combination thereof.

The interpreter component 102 can further include a match component 206 that can provide relevant query results regardless of source language (e.g., the language of the data targeted for query). Upon identification of the query language via the analyzer component 204, the match component 206 can locate relevant query results utilizing the translated query. For example, if the query was in Chinese from a user in China, the query can be translated into various languages in order to generate query results respective to each language all around the world. Thus, if the Chinese query is translated into English, the match component 206 can provide relevant query results from English-speaking locations based on the translated query. Upon identification of relevant query results in the various languages (disparate in comparison to the query), the interpreter component 102 can further translate the results back into the language of the original query to allow the user to find results regardless of the language associated therewith. It is to be appreciated that the match component 206 can be incorporated into the interpreter component 102 (as depicted), a stand-alone component, incorporated into a search component (not shown), and/or most any suitable combination thereof.

The interpreter component 102 can further utilize a range component 208 to manipulate the geographic search of the system 200. For example, the range component 208 can employ a radius-based search that allows a user to identify a particular geographic range to which a query can be applied. For instance, a user can select a particular geographic range to target for a query. In another example, a user can specify a radius from a home location (e.g., 10,000 miles from a home address, 20 miles from a home address, etc.). In still another example, a user can exclude particular areas so as to provide the most efficient search (e.g., target south of home since the north has been searched, etc.). It is to be appreciated that the range component 208 can utilize most any suitable manner in order to increase, decrease, expand, contrast, focus, etc. the geographic range of a query. Moreover, it is to be appreciated that the range component 208 can be incorporated into the interpreter component 102 (as depicted), a stand-alone component, incorporated into a search component (not shown), and/or most any suitable combination thereof.

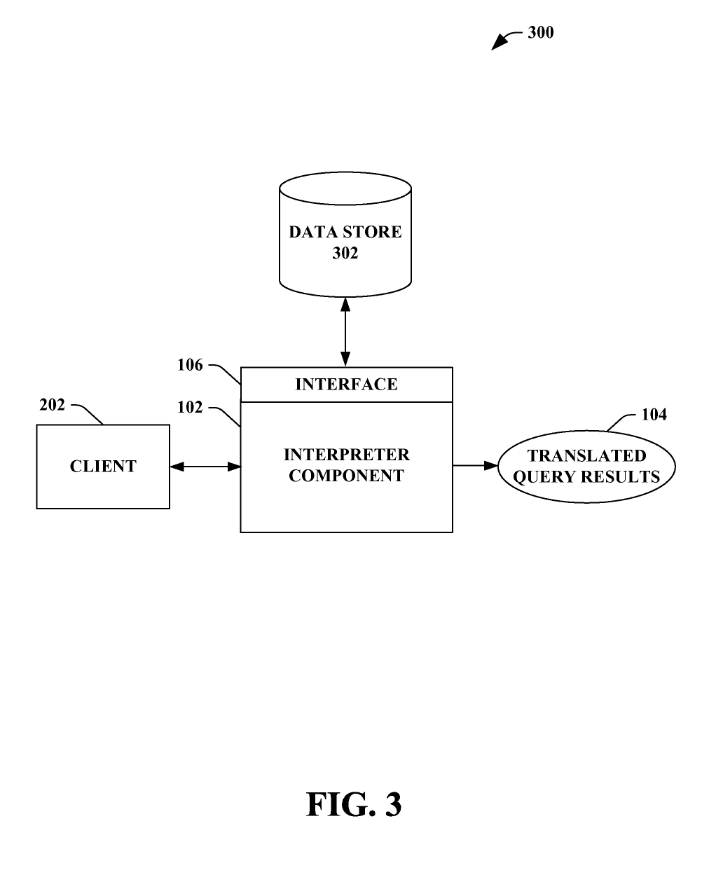

FIG. 3 illustrates a system 300 that facilitates translating a query into a disparate language to locate various listings regardless of the language related to the listing. The system 300 can employ the interpreter component 102 that can provide global searching of data within various languages. In particular, the interpreter component 102 can receive a query in a first language from the client 202 and translate the query into a disparate language in order to identify at least one relevant query result. Upon locating relevant query results in the disparate language, such results can be translated back into the substantially similar query language to enable a broad global search to identify a listing associated with commerce.

The system 300 can allow a user to perform a world-wide search whereby search terms can be automatically translated into one or more desired languages. For example, search result headlines and/or keywords and/or matched search terms in the search result content can be translated to the user's language. Moreover, currency can be auto-converted as well to the relevant country. Users can also set various search parameters including a particular distance (e.g., radius) from their home location (discussed above). For example, a user in southern California might prefer to search for an item in Mexico (or some specific location near the California/Mexico border rather than in Canada). Therefore, search results can be ranked by location and in terms of distance from the user's home location. In addition, search results can be ranked or ordered according to sites or vendors from which the user has had good experiences/purchases. Alternatively, search locations can be selected by the user through the use of a map and/or selection tool. The user interface (UI) can include a selection tool to allow a user to outline and/or encircle the desired area to search (e.g., draw a box or circle around an area on a map). Moreover, names of cities, states, and/or countries can also be clicked on or typed to select the desirable locations; however, all other locations can still be included in the search.

The system 300 can further include a data store 302 that can include any suitable data related to the interpreter component 102, and the translated query results 104. For instance, the data store can include language translation data, listings, items, commerce data, client data, client listings, services, goods, commodities, items for sale, a portion of a service, a purchasable item, an item related to commerce, host data, query data, range data, geographic data, language data, communication data, host settings, security configurations, most any suitable data related to the system 300, most any data related to commerce, and/or any suitable data related to providing translations in real-time corresponding to a query, etc.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 302 of the subject systems and methods is intended to comprise, without being limited to, these and any other suitable types of memory. In addition, it is to be appreciated that the data store 302 can be a server, a database, a hard drive, and the like.

For example, the interpreter component 102 can be utilized with a search component (not shown) that facilitates querying data. It is to be appreciated that the interpreter can be utilized with a search component, incorporated into a search component, and/or any combination thereof. In one instance, the search component can receive a query and provide query results based at least in part upon the received query, wherein the interpreter component 102 can translate the query in order to identify results in various languages and such results can then be translated back into the language used for the query. In other words, the search component can receive a query in language A, translate the query into disparate languages (e.g., language B, language C, etc.), identify relevant data based on the query, and provide such identified data translated back into language A (e.g., translated query results 104). Thus, the system 300 can provide query results associated with various commerce listings independent of language and on-the-fly in respect to the received query.

FIG. 4 illustrates a system 400 that facilitates implementing a language independent environment to identify a listing and translating such listing into a substantially similar language as a respective query. The system 400 can include the interpreter component 102 that can generate translated query results 104 independent of a source language associated with a received query. Specifically, the interpreter component 102 can receive a query in a language, translate the query into one of the language and/or a disparate language, search for relevant and/or matching data, and/or provide the query results in the language translated from the disparate language(s). In other words, the system 400 can enable the location of query results regardless of the source language associated with the query in order to expand the range of the query.

The interpreter component 102 can receive data via the interface 106, wherein the interpreter component 102 can query most any suitable data stored in a data store 302. It is to be appreciated that the interpreter component 102 can access most any suitable number of data stores 302 such as data store₁ to data store_{M}, where M is a positive integer. In one example, the interpreter component 102 can organize data within the data stores 302 based on the language such as a first data store for a first language, a second data store for a second language, a third data store for a third language, and so on and so forth. In another example, the data stores can be organized based on data associated with the origin of the data. Moreover, it is to be appreciated that the data associated with the system 400 can be organized in most any suitable manner and is not to be limiting on the subject innovation.

The interpreter component 102 can query most any suitable data stored on the data stores 302. In particular, the interpreter component 102 can query data related to commerce and/or a listing. Such commerce and/or listing data can be uploaded and/or provided by at least one client 402. It is to be appreciated that there can be most any suitable number of clients such as client₁ to client_{N}, where N is a positive integer. The clients 402 can upload a listing in a disparate language in comparison to the received query. Thus, the data stores 302 can store most any suitable data in various languages based on the data uploaded by the clients 402. For instance, upon translating the query, the query can be utilized to identify relevant data within the data stores 302 that had been uploaded by the clients 402. In particular, the query can be translated into most any suitable number of languages based on the number of languages existent within the data stores 302 (e.g., uploaded by the clients 402).

For example, two clients speaking Spanish and Dutch can upload listings associated with commerce in the respective languages, wherein such listings can be stored in the data stores accordingly. A query can be received in English by the interpreter component 102 to enable the translation of such query into the languages related to the data to be queried. In this example, the data to be queried is Spanish and Dutch. Thus, the query can be translated into Spanish and Dutch in order to ascertain relevant query results. Upon identifying relevant query results in Spanish and/or Dutch, such results can be translated into the query language (e.g., English in this example). In other words, the system 400 can enable a query to be received and relevant query results in various languages to be provided.

In another example, the interpreter component 102 can extract and/or generate keywords associated with a particular item. A new listing (e.g., item) can be entered into a database, wherein the interpreter component 102 can extract and/or generate keyword(s) associated with such listing. The original language version of the keyword(s) can be stored but a set of auto-translations on such keyword(s) can be performed so as to translate the keyword(s) into most any suitable language(s) available with the system 400. For instance, if a bike was to be sold utilizing the subject innovation, the following details can be entered: Category: Bikes; Transaction Type: For Sale; Color: Green; Description: Used bike for sale, has good index gears and new saddle. The system 400 can extract the following English keywords (e.g., comma separated) for search engine purposes: Bike, Used, Sale, Index, Gears, and Saddle. A Chinese site can take the English keywords and automatically translate them with the listing as, for example, as additional meta-data to facilitate identifying the listing in a foreign language.

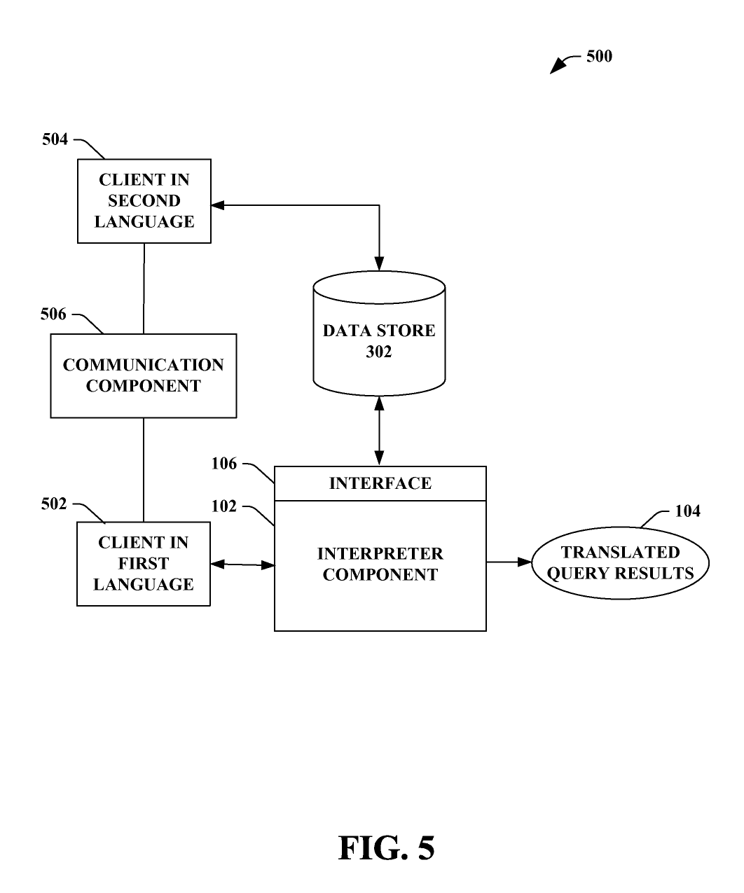

FIG. 5 illustrates a system 500 that facilitates employing universal communication corresponding to a first client and a second client. The system 500 can include the interpreter component 102 that can generate at least one translated result 104 based at least in part upon a search in various languages that can differ in comparison to a received query. In particular, the interpreter component 102 can receive a query result in a first language and translate such query in order to retrieve relevant query result(s) in disparate languages utilizing the translated query result. Once the relevant query results are retrieved, the interpreter component 102 can further translate the results into the first language.

A client in a first language 502 can provide a query to the interpreter component 102, wherein the query can be in the first language. The interpreter component 102 can translate the query to disparate languages in order to broaden the search so as to retrieve more results. As stated previously, the query can relate to a listing associated with commerce. The listing can be associated with an item, a good, a commodity, an item for sale, a portion of a service, a purchasable item, an item related to commerce, etc. For instance, the listing can be uploaded and/or provided by a client in a second language 504. The system 500 can further include a communication component 506 that can allow a communication forum for the client in a first language 502 and the client in the second language 504. For instance, the communication component 506 can provide translations in relation to email communication, instant messaging communication, currency conversions, message board communication, most any suitable communication between two or more languages, etc. In other words, the communication component 506 can enable two clients speaking disparate languages to communicate about the listing identified by the interpreter component 102 as a relevant query result.

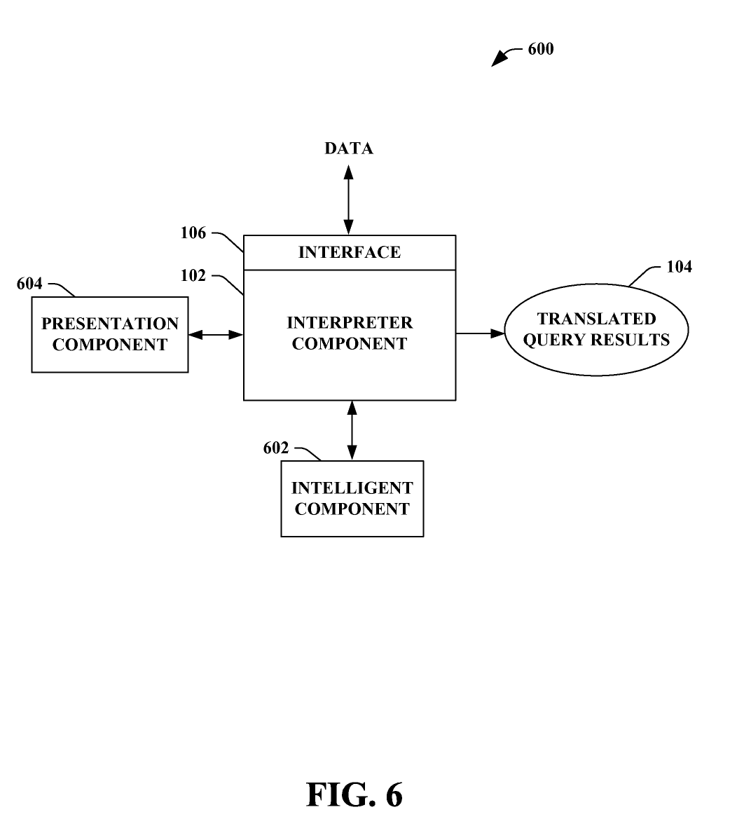

FIG. 6 illustrates a system 600 that employs intelligence to facilitate identifying a portion of data in a disparate language based on a translation of a received query. The system 600 can include the interpreter component 102, the interface 106, and the translated query results 104, wherein it is to be appreciated that the interpreter component 102, the translated query results 104, and the interface 106 can be substantially similar to respective components, translated query results, and interfaces described in previous figures. The system 600 further includes an intelligent component 602. The intelligent component 602 can be utilized by the interpreter component 102 to facilitate identifying commerce listings regardless of source language. For example, the intelligent component 602 can infer languages, translations, listings, commerce items, communication settings, query relevancy, query range, user preferences, list host settings/configuration, security techniques, language analysis, identification of listings based on the query, geographic data, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The interpreter component 102 can further utilize a presentation component 604 that provides various types of user interfaces to facilitate interaction between a user and any component coupled to the interpreter component 102. As depicted, the presentation component 604 is a separate entity that can be utilized with the interpreter component 102. However, it is to be appreciated that the presentation component 604 and/or similar view components can be incorporated into the interpreter component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the interpreter component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

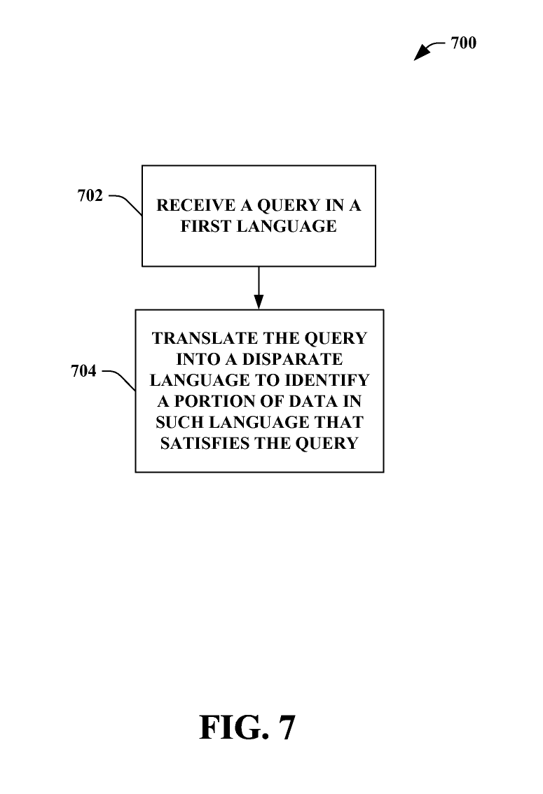

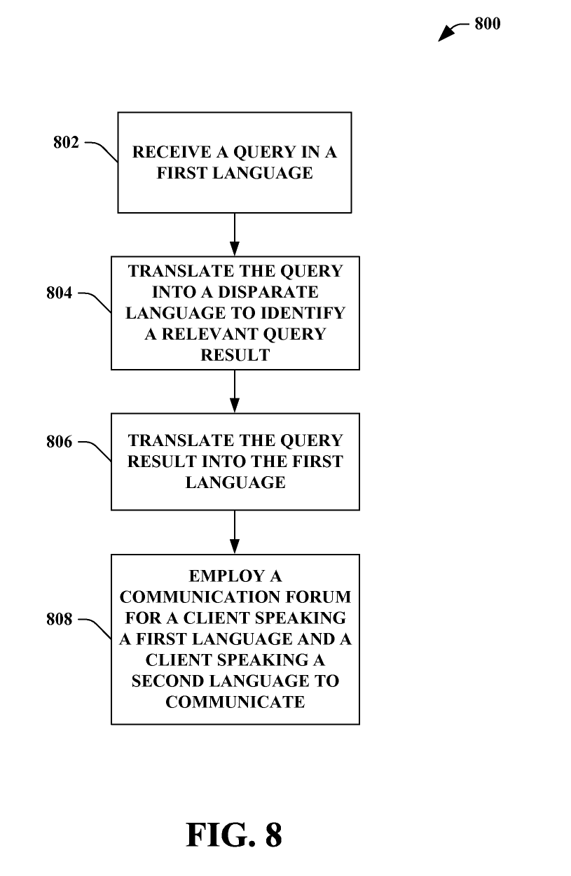

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a methodology 700 for identifying query results related to a listing associated with commerce independent of a language. At reference numeral 702, a query in a first language can be received. The query can be, for instance, associated with an item, a good, a commodity, an item for sale, a portion of a service, a purchasable item, an item related to commerce, etc. At reference numeral 704, the query can be translated into a disparate language to identify a portion of data in such language that satisfies the query. In other words, a query can be received and translated into a disparate language in order to identify a result that satisfies the criteria/query. By translating the query into a disparate language, the query results obtained can be from a larger scope rather than being limited to the language of the received query.

For example, a query related to a listing such as a rare coin can be received in English. Such query can be translated in disparate languages order to allow the search of relevant matches across the globe. Once translated, the query results can be identified in the various languages which can enable the query to be satisfied regardless of the language associated with at least one of the query and/or the listing. Thus, a client with a listing in Japanese that satisfies the query in English can be provided to the English query, wherein conventional techniques would not identify such listing based on the language boundary. Moreover, such identified query results can be obtained dynamically, in real-time, and/or on-the-fly.

FIG. 8 illustrates a methodology 800 that facilitates implementing a commerce environment for communication independent of a language boundary. At reference numeral 802, a query in a first can be received. It is to be appreciated that the query can be in most any suitable language. At reference numeral 804, the query can be translated into a disparate language to identify a relevant query result. In other words, the query can be translated into most any suitable language in order to locate a portion of data that meets and/or satisfies the query regardless of the first language of the query and/or the language associated with the data searched and/or queried.

At reference numeral 806, the query result obtained and/or identified can be translated into the first language of the received query. By translating such result from the listing language to the query language, the query originator (e.g., person, client, machine, etc.) can comprehend such query results. Thus, a query received in English can be translated to Spanish, French, Italian, most any suitable language, a disparate language in comparison to English, etc. in order to identify relevant query results. Upon identification of such results in the various languages, the results can be translated into English to enable comprehension of the query provider.

At reference numeral 808, a communication forum can be employed for a client speaking a first language and a client speaking a second language to communicate. In particular, the communication forum can provide data communication between two disparate languages in connection with a listing related to commerce. For instance, the communication forum can provide translations in relation to email communication, instant messaging communication, currency conversions, message board communication, most any suitable communication between two or more languages, etc. In other words, the communication forum can enable two clients speaking disparate languages to communicate about the listing identified as a relevant query result.

In another example, keywords associated with a particular item can be extracted and/or generated. A new listing (e.g., item) can be entered into a database, wherein keyword(s) associated with the listing can be extracted and/or generated keyword(s) associated with such listing. The original language version of the keyword(s) can be stored but a set of auto-translations on such keyword(s) can be performed so as to translate the keyword(s) into most any suitable language(s) utilized. For instance, if a bike was to be sold utilizing the subject innovation, the following details can be entered: Category: Bikes; Transaction Type: For Sale; Color: Green; Description: Used bike for sale, has good index gears and new saddle. The system 400 can extract the following English keywords (e.g., comma separated) for search engine purposes: Bike, Used, Sale, Index, Gears, and Saddle. A Chinese site can take the English keywords and automatically translate them with the listing as, for example, as additional meta-data to facilitate identifying the listing in a foreign language

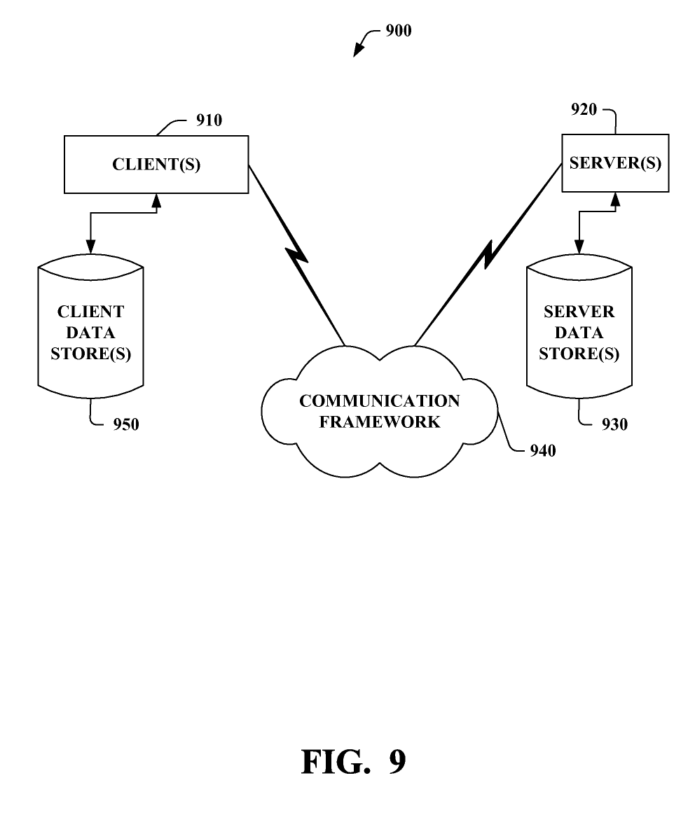

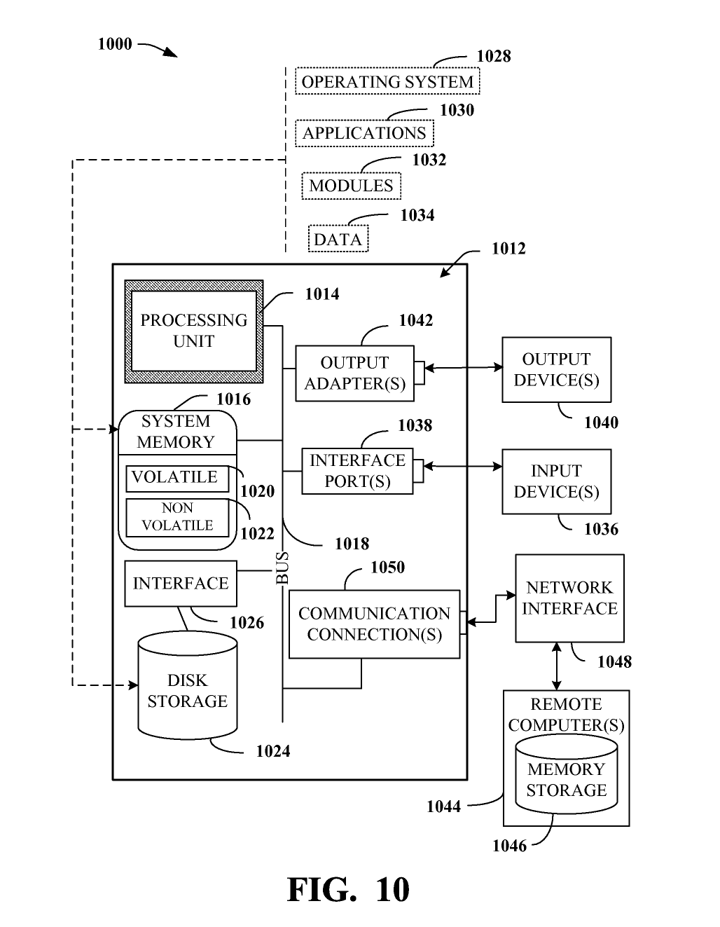

In order to provide additional context for implementing various aspects of the claimed subject matter, FIGS. 9-10 and the following discussion is intended to provide a brief, general description of a suitable computing environment in which the various aspects of the subject innovation may be implemented. For example, an interpreter component that facilitates identifying a portion of data in a disparate language based on a translation of a received query, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 940 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates querying data, comprising:
an interface component that receives data related to a portion of a listing associated with commerce in a first language; and
an interpreter component that translates a query in a second language to the first language to enable identification of a portion of the listing in the first language.

2. The system of claim 1, the portion of the listing is translated into the second language in order to provide at least one translated query result.

3. The system of claim 1, further comprising the interpreter component translates an entirety of the listing based upon a click-through of the translated query result.

4. The system of claim 1, the query relates to at least one of an item, a good, a commodity, an item for sale, a portion of a service, a purchasable item, or an item related to commerce.

5. The system of claim 1, the listing includes a portion of at least one of a good, an item, a commodity, an item for sale, a portion of a service, a purchasable item, or an item related to commerce.

6. The system of claim 1, further comprising a client that provides the query in the second language, the client speaks at least the second language.

7. The system of claim 1, further comprising a client that provides the listing in the first language, the client speaks at least the first language.

8. The system of claim 1, further comprising an analyzer component that analyzes the received query in order to facilitate translating such query into a disparate language.

9. The system of claim 1, further comprising a match component that identifies a relevant query result regardless of the first language.

10. The system of claim 1, further comprising a range component that employs a manipulation associated with a geographic location related to the query.

11. The system of claim 10, the range component employs a radius-based search to identify a particular geographic range to which the query applies.

12. The system of claim 11, the range component employs a radius from a resident address related to a source of the query.

13. The system of claim 12, the range component employs at least one of an increase, a decrease, an expansion, a contraction, or a focus on the geographic range of the query.

14. The system of claim 1, further comprising a communication component that employs a communication forum for a client in a first language and a client in a second language.

15. The system of claim 14, the communication component provides a translation in relation to at least one of an email communication, an instant messaging communication, a currency conversion, or a message board communication.

16. A computer-implemented method that facilitates providing query results independent of a language, comprising:
receiving a data query related to a listing associated with commerce in a first language;
translating the data query to a disparate language; and
identifying a portion of data in the disparate language that satisfies the data query.

17. The method of claim 16, the portion of the data is translated into the first language in order to provide at least one translated query result.

18. The method of claim 16, the query relates to at least one of an item, a good, a commodity, an item for sale, a portion of a service, a purchasable item, or an item related to commerce.

19. The method of claim 16, the listing includes a portion of at least one of a good, an item, a commodity, an item for sale, a portion of a service, a purchasable item, or an item related to commerce.

20. A computer-implemented system that facilitates querying data, comprising:
means for receiving data related to a portion of a listing associated with commerce in a first language; and
means for translating a query in a second language to the first language to enable identification of a portion of the listing in the first language.
